(19) United States
(12) Patent Application Publication
(10) Pub. No.: US 2013/0135037 A1
(43) Pub. Date: May 30, 2013

(54) VOLTAGE MULTIPLYING CIRCUIT, SIGNAL SWITCH CHIP AND IMPEDANCE ADJUSTING METHOD THEREOF

(71) Applicant: Yi-Chung Tsai, New Taipei City (TW)

(72) Inventor: Yi-Chung Tsai, New Taipei City (TW)

(21) Appl. No.: 13/684,235

(22) Filed: Nov. 22, 2012

(30) Foreign Application Priority Data
Nov. 24, 2011 (TW) 100143141

(51) Int. Cl. G05F 3/02

(52) U.S. Cl. CPC G05F 3/02
USPC 327/538

(57) ABSTRACT

A signal switch chip with a chip voltage is disclosed. The signal switch chip includes a transmission gate and a voltage multiplying circuit. The voltage multiplying circuit receives a basic voltage to generate a multiplying voltage, and the multiplying voltage is N times the basic voltage. N is a positive integer, and N is greater than 1. The transmission gate is coupled to the multiplying circuit and receives the multiplying voltage to adjust an equivalent impedance of the transmission gate, and the multiplying voltage is higher than the chip voltage.

### CROSS-REFERENCE TO RELATED APPLICATION

This application claims the priority benefit of Taiwan application serial no. 100143141, filed on Nov. 24, 2011. The entirety of the above-mentioned patent application is hereby incorporated by reference herein and made a part of this specification.

### BACKGROUND OF THE INVENTION

1. Field of the Invention

The disclosure is related to a signal switch chip, more particularly, to a signal switch chip having a voltage multiplying circuit.

2. Description of Related Art

With the development of electronic technologies, electronic devices have become indispensable in our daily lives. Owing to increasing demands on information, how to transmit the information rapidly to the users without distortion has become a primary issue on designing electronic products.

In an exemplary conventional signal switcher, the so-called transmission gate has been frequently applied to transmit signals at high speed. As known to people having ordinary skill in the art, the transmission gate is composed of a P-type transistor and an N-type transistor which are connected to each other. The P-type and the N-type transistor are switched on simultaneously to conduct the transmission gate effectively and thereby transmit the signals at high speed.

### SUMMARY OF THE INVENTION

In an embodiment of the disclosure, a signal switch chip with a chip voltage is provided. The signal switch chip includes a voltage multiplying circuit and a transmission gate. The voltage multiplying circuit receives a basic voltage to generate a multiplying voltage, and the multiplying voltage is N times the basic voltage. Here, N is a positive integer greater than 1. The transmission gate is coupled to the voltage multiplying circuit and receives the multiplying voltage to adjust an equivalent impedance of the transmission gate. The multiplying voltage is higher than the chip voltage.

In an embodiment of the disclosure, a voltage multiplying circuit that includes a first voltage multiplying capacitor, a second voltage multiplying capacitor, an output capacitor, a first voltage transmission channel, and a second voltage transmission channel is provided. One end of the first voltage multiplying capacitor receives a first elected signal, and the other end generates a first control signal. One end of the second voltage multiplying capacitor receives a second elected signal, and the other end generates a second control signal. One end of the output capacitor is serially connected to an output terminal, and the other end is serially connected to a reference ground terminal. The first voltage transmission channel is coupled to the output terminal, a reference voltage end, and the first voltage multiplying capacitor, and the first voltage multiplying capacitor receives a basic voltage. According to the second control signal, the first voltage transmission channel selects to conduct a coupling route between the first voltage multiplying capacitor and the basic voltage or a coupling route between the first voltage multiplying capacitor and the output terminal. The second voltage transmission channel is coupled to the output terminal, the reference voltage end, and the second voltage multiplying capacitor, and the second voltage multiplying capacitor receives the basic voltage. According to the first control signal, the second voltage transmission channel selects to conduct a coupling route between the second voltage multiplying according to the second control signal and the basic voltage or a coupling route between the second voltage multiplying capacitor and the output terminal.

In an embodiment of the disclosure, an impedance adjusting method of a signal switch chip is provided. The signal switch chip includes a chip voltage and a transmission gate. The impedance adjusting method includes receiving a basic voltage to generate a multiplying voltage. Here, the multiplying voltage is N times the basic voltage, and N is a positive integer greater than 1. The impedance adjusting method further includes providing the multiplying voltage to the transmission gate, and the multiplying voltage is higher than the chip voltage.

As described above, the voltage multiplying circuit provided in the disclosure is capable of effectively reducing an impedance when the signal switch chip is conducted, and multi-level voltage multiplying circuits may be serially connected to generate an impedance adjusting signal required for effectively adjusting the impedance of the signal switch chip. Thereby, the signal switch chip may transmit high-speed signals rapidly and completely.

These and other exemplary embodiments, features, and aspects of the disclosure will be described and become more apparent from the detailed description of exemplary embodiments when read in conjunction with accompanying drawings.

### BRIEF DESCRIPTION OF THE DRAWINGS

FIG. 1 is a schematic view of a signal switch chip according to an embodiment of the disclosure.

FIG. 2 is a schematic view of a voltage multiplying circuit according to an embodiment of the disclosure.

FIG. 3 is a schematic view of a voltage multiplying circuit according to another embodiment of the disclosure.

FIG. 4 is a schematic view of a cascaded voltage multiplying circuit.

FIG. 5 is a flow chart of an impedance adjusting method of the signal switch chip according to an embodiment of the disclosure.

### DESCRIPTION OF THE EMBODIMENTS

The disclosure provides a voltage multiplying circuit, which is used for reducing an impedance when a signal switch chip is conducted, such that the signal switch chip may transmit a high-speed signal rapidly and completely, and a tolerance level of the signal switch chip to a common mode voltage may also be raised. In order to make the disclosure more comprehensible, embodiments are described below as the examples to prove that the disclosure can actually be realized.

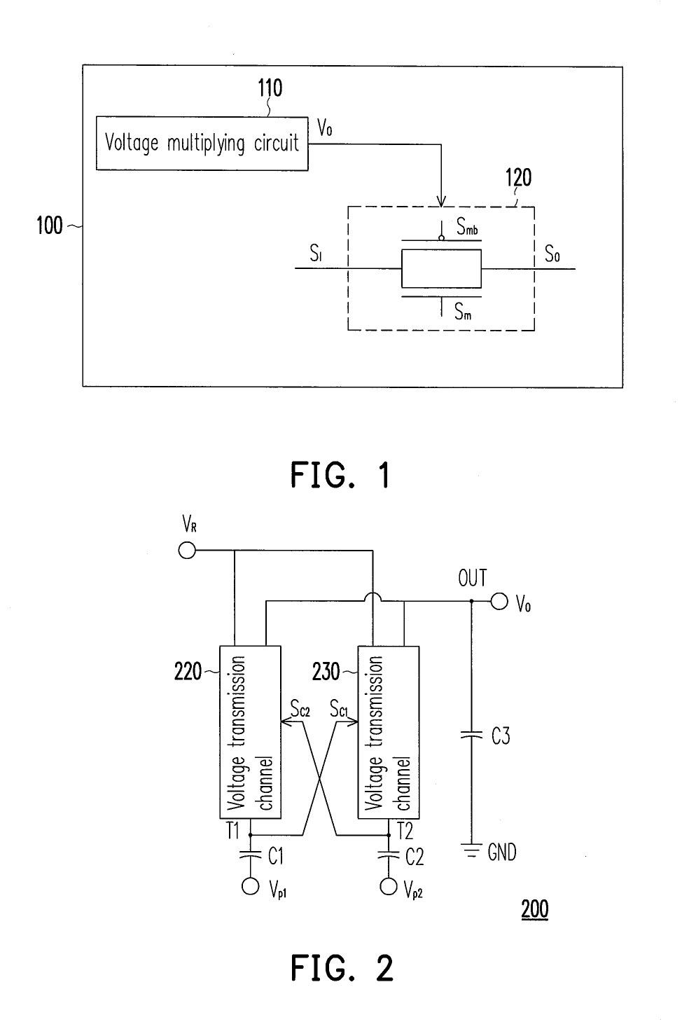

FIG. 1 is a schematic view of a signal switch chip according to an embodiment of the disclosure. A signal switch chip 100 of the present embodiment includes a chip voltage (not shown). The signal switch chip 100 includes a transmission gate 120 and a voltage multiplying circuit 110. The transmission gate 120 receives a multiplying voltage Vₒ generated by the voltage multiplying circuit 110, and the multiplying voltage Vₒ serves as impedance adjusting signals Sₘ and S_{mb}. An equivalent impedance provided by the transmission gate 120 is adjusted according to the impedance adjusting signals Sₘ and S_{mb}, and the impedance adjusting signals Sₘ and S_{mb} are reverse to each other. In addition, since the chip voltage is the power supply provided by the signal switch chip 100 to the transmission gate 120 and the voltage multiplying circuit 110, a voltage (except for the multiplying voltage generated by the voltage multiplying circuit 110) received at the transmission gate 120 and the voltage multiplying circuit 110 is normally no higher than (i.e., lower than or equal to) the chip voltage.

It should be mentioned that the multiplying voltage Vₒ of the voltage multiplying circuit 110 is higher than the chip voltage. In other words, when the equivalent impedance provided by the transmission gate 120 is in a low impedance state, the impedance adjusting signals Sₘ and S_{mb} generated by the multiplying voltage Vₒ are respectively a high level voltage (i.e., equal to the output voltage Vₒ) and a low level voltage (i.e., equal to the ground voltage at 0 volt). Since a voltage level of the impedance adjusting signal Sₘ is higher than that of the chip voltage, the equivalent impedance provided by the transmission gate 120 may be further lowered down, and thereby the difference between an output signal Sₒ and a high-speed signal S_{I} becomes more insignificant.

FIG. 2 is a schematic view of a voltage multiplying circuit according to an embodiment of the disclosure. A voltage multiplying circuit 200 of the present embodiment includes voltage multiplying capacitors C1 and C2, an output capacitor C3, and voltage transmission channels 220 and 230. In the present embodiment, one end of the voltage multiplying capacitor C1 generates a control signal S_{C1}, and the other end receives an elected signal V_{P1}. One end of the voltage multiplying capacitor C2 generates a control signal S_{C2}, and the other end receives an elected signal V_{P2}. The output capacitor C3 serially connects to an output terminal OUT (outputting the multiplying voltage Vₒ) and a reference ground terminal GND.

The voltage transmission channel 220 includes three coupling ends. A first end is coupled to the output terminal OUT; a second end is coupled to an end point T1 at which the control signal S_{C1} is generated by the voltage multiplying capacitor C1; a third end receives a basic voltage V_{R}. The basic voltage V_{R} may directly refer to the chip voltage of the signal switch chip 100 or may be partially reduced to comply with certain standard. According to the control signal S_{C2} generated by the voltage multiplying capacitor C2, the voltage transmission channel 220 selects to couple the end point T1 to the basic voltage V_{R} or to couple the end point T1 to the output terminal OUT. Similarly, according to the control signal S_{C1} generated by the voltage multiplying capacitor C1, the voltage transmission channel 230 selects to couple the end point T2 at which the control signal S_{C2} is generated by the voltage multiplying capacitor C2 to the basic voltage V_{R} or to couple the end point T2 to the output terminal OUT.

When the voltage transmission channel 220 selects to couple the end point T1 of the voltage multiplying capacitor C1 to the basic voltage V_{R}, the voltage transmission channel 230 selects to couple the end point T2 of the multiplying capacitor C2 to the output terminal OUT. When the voltage transmission channel 220 selects to couple the end point T1 of the voltage multiplying capacitor C1 to the output terminal OUT, the voltage transmission channel 230 selects to couple the end point T2 of the multiplying capacitor C2 to the basic voltage V_{R}.

The voltage transmission channel 230 also includes three coupling ends. A first end is coupled to the output terminal OUT; a second end is coupled to the end point T2 at which the control signal S_{C2} is generated by the voltage multiplying capacitor C2; a third end receives a basic voltage V_{R}. The voltage transmission channel 230 selects to couple the end point T2 to the basic voltage V_{R} or to couple the end point T2 to the output terminal OUT according to the control signal S_{C1} generated by the voltage multiplying capacitor C1. Similarly, the voltage transmission channel 220 selects to couple the end point T1 at which the control signal S_{C1} is generated by the voltage multiplying capacitor C1 to the basic voltage V_{R} or to couple the end point T1 to the output terminal OUT according to the control signal S_{C2} generated by the voltage multiplying capacitor C2.

When the voltage transmission channel 230 selects to couple the end point T2 of the voltage multiplying capacitor C2 to the basic voltage V_{R}, the voltage transmission channel 220 selects to couple the end point T1 of the multiplying capacitor C1 to the output terminal OUT. When the voltage transmission channel 230 selects to couple the end point T2 of the voltage multiplying capacitor C2 to the output terminal OUT, the voltage transmission channel 220 selects to couple the end point T1 of the multiplying capacitor C1 to the basic voltage V_{R}.

Therefore, an elected signal V_{P1} and an elected signal V_{P2} are transitioned between the basic voltage V_{R} and the reference ground terminal GND, and a phase of the elected signal V_{P1} and a phase of the elected signal V_{P2} are reverse to each other.

As to the overall operation of the voltage multiplying circuit 200, the voltage transmission channel 220 selects to couple the end point T1 to the basic voltage V_{R}. At the same time, the elected signal V_{P1}, which is equal to the reference ground voltage GND, is provided to the other end of the voltage multiplying capacitor C1. Here, the voltage multiplying capacitor C1 is charged according to the basic voltage V_{R}, and a voltage on the end point T1 is equal to the basic voltage V_{R}.

The voltage transmission channel 220 then selects to couple end point T1 to the output terminal OUT, and the elected signal V_{P1} is raised to be equal to the basic voltage V_{R}. Since the voltage multiplying capacitor C1 has a voltage equal to the sum of the basic voltage V_{R} and the elected signal V_{P1} which is raised to be equal to the basic voltage V_{R}, a voltage on the end point T1 is simultaneously pulled up to approximately 2 times the basic voltage V_{R}. Furthermore, the end point T1 is coupled to the output terminal OUT. Therefore, the output capacitor C3 is charged according to the voltage on the end point T1, which is 2 times the basic voltage V_{R}.

In addition, a voltage of the control signal S_{C1} may also be equal to 2 times the basic voltage V_{R}, and the voltage transmission channel 230 may select to couple the end point T2 to the basic voltage V_{R}. Under a situation that the voltage multiplying capacitor C2 receives the elected signal V_{P2}, which is equal to the reference ground voltage, a voltage on the end point T2 is charged according to the basic voltage V_{R}.

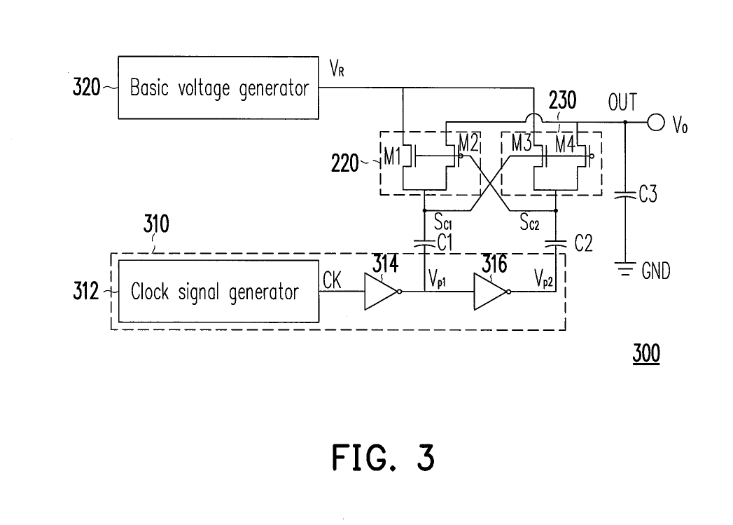

FIG. 3 is a schematic view of a voltage multiplying circuit according to another embodiment of the disclosure. The difference between the present embodiment and the previous embodiment lies in that a voltage multiplying circuit 300 described herein further includes an elected signal generator 310 and a basic voltage generator 320. The elected signal generator 310 further includes a clock signal generator 312 and phase inverters 314 and 316, and the elected signal generator 310 is coupled to the voltage multiplying capacitors C1 and C2 to generate the elected signals V_{P1} and V_{P2}. The clock signal generator 312 generates a clock signal CK. The phase inverter 314 is coupled to the clock signal generator 312, the voltage multiplying capacitor C1, and the phase inverter 316. Besides, the phase inverter 314 receives the clock signal CK generated by the clock signal generator 312 and generates the elected signal V_{P1} according to the clock signal CK.

In the present embodiment of the disclosure, the phase inverter 316 is coupled to the phase inverter 314 and the voltage multiplying capacitor C2. The phase inverter 316 receives the elected signal V_{P1} outputted by the phase inverter 314 and generates the elected signal V_{P2} according to the elected signal V_{P1}. The elected signal V_{P2} is employed to elect voltage multiplying capacitor C2.

In the present embodiment, as shown in FIG. 3, the voltage transmission channel 220 includes transistors M1 and M2; the transistor M1 is, for example, an N-type transistor, and the transistor M2 is, for example, a P-type transistor. The voltage transmission channel 230 includes transistors M3 and M4; the transistor M3 is, for example, the N-type transistor, and the transistor M4 is, for example, the P-type transistor.

The transistor M1 includes a first end (source), a second end (drain), and a control end (gate). The first end of the transistor M1 receives the basic voltage V_{R} generated by the basic voltage generator 320, the second end is coupled to the voltage multiplying capacitor C1, and the control end receives the control signal S_{C2}. The transistor M2 includes a first end (source), a second end (drain), and a control end (gate). The first end of the transistor M2 is coupled to the output terminal OUT, the second end is coupled to the voltage multiplying capacitor C1, and the control end receives the control signal S_{C2}. The control signal S_{C2} is generated after the phase inverter 316 receives the elected signal V_{P1} and generates the elected signal V_{P2} to elect the voltage multiplying capacitor C2, and the control signal S_{C2} serves to determine an on/off state of the transistors M1 and M2. In addition, in the present embodiment of the disclosure, a type of the transistor M1 and a type of the transistor M2 are complementary. Therefore, when the control signal S_{C2} controls the on/off state of the transistors M1 and M2, the control signal S_{C2} may make one of the transistors M1 and M2 to be in an on state while the other transistor is in an off state. Furthermore, as long as elements are capable of performing the function of a switch, and types of the elements are also complementary, such elements should fall within the scope of the disclosure.

Moreover, the transistor M3 in the voltage transmission channel 230 includes a first end (source), a second end (drain), and a control end (gate). The first end of the transistor M3 receives the basic voltage V_{R} generated by the basic voltage generator 320, the second end is coupled to the voltage multiplying capacitor C2, and the control end receives the control signal S_{C1}. The transistor M4 includes a first end (source), a second end (drain), and a control end (gate). The first end of the transistor M4 is coupled to the output terminal OUT, the second end is coupled to the voltage multiplying capacitor C2, and the control end receives the control signal S_{C1}. The control signal S_{C1} is generated after the phase inverter 314 receives the clock signal CK and generates the elected signal V_{P1} to elect the voltage multiplying capacitor C1, and the control signal S_{C1} serves to determine an on/off state of the transistors M3 and M4. In addition, in the present embodiment of the disclosure, a type of the transistor M3 and a type of the transistor M4 are complementary. Therefore, when the control signal S_{C1} controls the on/off state of the transistors M3 and M4, the control signal S_{C1} may make one of the transistors M3 and M4 to be in an on state while the other transistor is in an off state. Similarly, as long as elements are capable of performing the function of a switch, and types of the elements are also complementary, such elements should fall within the scope of the disclosure.

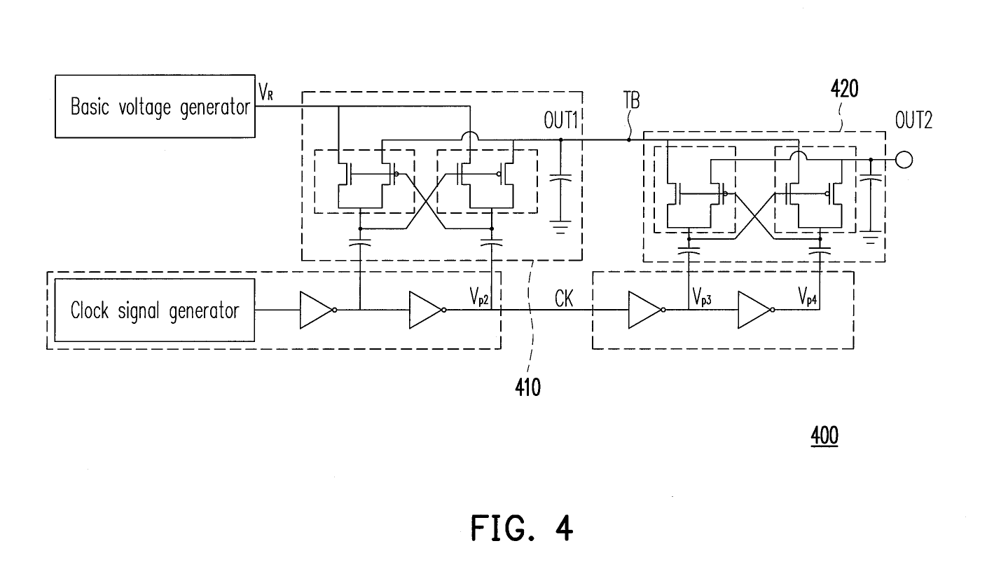

FIG. 4 illustrates another embodiment of the disclosure and is a schematic view of a serially connected voltage multiplying circuit. An output terminal OUT1 of a first-level voltage multiplying circuit 410 is serially connected to a basic voltage end TB of a second-level voltage multiplying circuit 420. A voltage on the output terminal OUT1 serves as a basic voltage of the second-level voltage multiplying circuit 420. The elected signal V_{P2} of the first-level voltage multiplying circuit 410 is transmitted to and received by the second-level voltage multiplying circuit 420 and serves as required elected signals V_{P3} and V_{P4} of the second-level voltage multiplying circuit 420. In the present embodiment, the elected signal V_{P3} is a reverse signal of the elected signal V_{P2}, and the elected signal V_{P4} is a reverse signal of the elected signal V_{P3}.

The second-level voltage multiplying circuit 420 and the first-level voltage multiplying circuit 410 are operated in the same manner. Therefore, when an output voltage of the output terminal OUT1 is 2 times the basic voltage V_{R}, an output voltage of an output terminal OUT2 of the second-level voltage multiplying circuit 420 is 3 times the basic voltage V_{R}. As described above, when multi-level voltage multiplying circuits (i.e., N level, N is a positive integer greater than 1) are serially connected, an output terminal of the last-level voltage multiplying circuit may generate a voltage approximately equal to (N+1) times the basic voltage V_{R}.

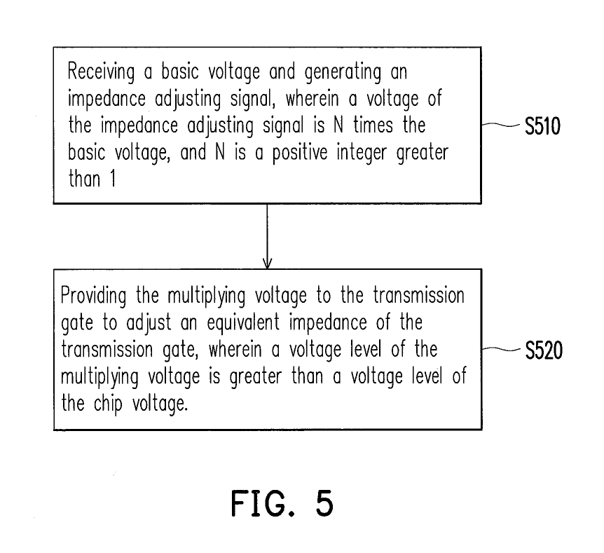

FIG. 5 is a flow chart of an impedance adjusting method of a signal switch chip according to an embodiment of the disclosure. The signal switch chip transmits a high-speed signal through a voltage multiplying circuit and a transmission gate. The impedance adjusting method of the signal switch chip includes receiving a basic voltage and generating an impedance adjusting signal (S510), wherein a voltage of the impedance adjusting signal is N times the basic voltage, and N is a positive integer greater than 1. The impedance adjusting signal is then provided to a control end of the signal switch chip to adjust the equivalent impedance (S520) when the signal switch chip is conducted. Here, the voltage of the impedance adjusting signal is greater than the maximum value of a voltage level of the high-speed signal. The details of the impedance adjustment of the signal switch chip of the disclosure are explained in the previously-mentioned embodiments, and thus no further description is provided hereafter.

To sum up, the signal switch chip of the disclosure has at least the following advantages.

1. The voltage multiplying circuit provided in the disclosure is capable of effectively reducing an impedance when the signal switch chip is conducted, and multi-level voltage multiplying circuits may be serially connected to generate an impedance adjusting signal required for effectively adjusting the impedance of the signal switch chip, such that the signal switch chip may transmit signal rapidly and completely.

2. The disclosure discloses and solves an issue caused by the conventional signal switch chip composed of voltage-withstanding elements. In addition, according to an embodiment of the disclosure, an issue of large impedance and large capacitive load occurring when the signal switch chip is conducted is resolved.

Although the disclosure has been described with reference to the above embodiments, it will be apparent to one of the ordinary skill in the art that modifications and variations to the described embodiments may be made without departing from the spirit and scope of the disclosure. Accordingly, the scope of the disclosure will be defined by the attached claims not by the above detailed descriptions.

What is claimed is:

1. A signal switch chip having a chip voltage, comprising:
a voltage multiplying circuit, receiving a basic voltage to generate a multiplying voltage, wherein the multiplying voltage is N times the basic voltage, and N is a positive integer greater than 1; and
a transmission gate, coupling the voltage multiplying circuit and receiving the multiplying voltage to adjust an equivalent impedance of the transmission gate, wherein the multiplying voltage is higher than the chip voltage.

2. The signal switch chip according to claim 1, wherein the chip voltage is higher than or substantially equal to the basic voltage.

3. The signal switch chip according to claim 1, wherein the voltage multiplying circuit comprises:
a first voltage multiplying capacitor having one end receiving a first elected signal and the other end generating a first control signal;
a second voltage multiplying capacitor having one end receiving a second elected signal and the other end generating a second control signal;
an output capacitor, serially connecting an output terminal and a reference ground terminal;
a first transmission channel coupling the output terminal and the first voltage multiplying capacitor and receiving the basic voltage, wherein the first transmission channel decides whether to conduct a coupling route between the first voltage multiplying capacitor and the basic voltage or to conduct a coupling route between the first voltage multiplying capacitor and the output terminal according to the second control signal; and
a second transmission channel coupling the output terminal and the second voltage multiplying capacitor and receiving the basic voltage, wherein the second transmission channel decides whether to conduct a coupling route between the second voltage multiplying capacitor and the basic voltage or to conduct a coupling route between the second voltage multiplying capacitor and the output terminal according to the first control signal.

4. The signal switch chip according to claim 3, wherein the first and the second elected signals are transitioned between the basic voltage and a reference ground voltage, and a phase of the first elected signal and a phase of the second elected signal are reverse to each other.

5. The signal switch chip according to claim 4, wherein when the first voltage transmission channel selects to conduct the coupling route between the first voltage multiplying capacitor and the basic voltage, the first elected signal is equal to the reference ground voltage, and when the second voltage transmission channel selects to conduct the coupling route between the second voltage multiplying capacitor and the output terminal, the second elected signal is equal to the basic voltage.

6. The signal switch chip according to claim 4, wherein when the first voltage transmission channel selects to conduct the coupling route between the first voltage multiplying capacitance and the output terminal, the first elected signal is equal to the basic voltage, and when the second voltage transmission channel selects to conduct the coupling route between the second voltage multiplying capacitance and the basic voltage, the second elected signal is equal to the reference ground voltage.

7. The signal switch chip according to claim 3, wherein the voltage multiplying circuit further comprises:
an elected signal generator, coupling the first and the second voltage multiplying capacitors to generate the first and the second elected signals, wherein the elected signal generator comprises:
a clock signal generator, generating a clock signal;
a first phase inverter, coupling the clock signal generator and receiving the clock signal to generate the first elected signal accordingly; and
a second phase inverter, coupling the first phase inverter and receiving the first elected signal to generate the second elected signal accordingly.

8. The signal switch chip according to claim 3, wherein the voltage multiplying circuit further comprises:
a basic voltage generator, coupling the first and the second voltage transmission channels to generate the basic voltage.

9. A voltage multiplying circuit comprising:
a first voltage multiplying capacitor having one end receiving a first elected signal and the other end generating a first control signal;
a second voltage multiplying capacitor having one end receiving a second elected signal and the other end generating a second control signal;
an output capacitor serially connecting an output terminal and a reference ground terminal;
a first transmission channel, coupling the output terminal and the first voltage multiplying capacitor and receiving a basic voltage, wherein the first transmission channel decides whether to conduct a coupling route between the first voltage multiplying capacitor and the basic voltage or to conduct a coupling route between the first voltage multiplying capacitor and the output terminal according to the second control signal; and
a second transmission channel, coupling the output terminal and the second voltage multiplying capacitor and receiving the basic voltage, wherein the second transmission channel decides whether to conduct a coupling route between the second voltage multiplying capacitor and the basic voltage or to conduct a coupling route between the second voltage multiplying capacitor and the output terminal according to the first control signal.

10. The voltage multiplying circuit according to claim 9, wherein the first and the second elected signals are transitioned between the basic voltage and a reference ground voltage, and a phase of the first elected signal and a phase of the second elected signal are reverse to each other.

11. The voltage multiplying circuit according to claim 10, wherein when the first voltage transmission channel selects to conduct the coupling route between the first voltage multiplying capacitor and the basic voltage, the first elected signal is equal to the reference ground voltage, the second voltage transmission channel selects to conduct the coupling route between the second voltage multiplying capacitor and the output terminal, the second elected signal is equal to the basic voltage.

12. The voltage multiplying circuit according to claim 10, wherein when the first voltage transmission channel selects to conduct the coupling route between the first voltage multiplying capacitor and the output terminal, the first elected signal is equal to the basic voltage, the second voltage transmission channel selects to conduct the coupling route between the second voltage multiplying capacitor and the basic voltage, the second elected signal is equal to the reference ground voltage.

13. The voltage multiplying circuit according to claim 9, further comprising:
an elected signal generator, generating the first and the second elected signals.

14. The voltage multiplying circuit according to claim 13, wherein the elected signal generator comprises:
a clock signal generator, generating a clock signal;
a first phase inverter, coupling the clock signal generator and receiving the clock signal to generate the first elected signal; and
a second phase inverter, coupling the first phase inverter and receiving the first elected signal to generate the second elected signal.

15. The voltage multiplying circuit according to claim 9, further comprising:
a basic voltage generator, generating the basic voltage.

16. The voltage multiplying circuit according to claim 9, wherein the first voltage transmission channel comprises:
a first transistor having an end receiving the basic voltage, a second end coupling the first voltage multiplying capacitor, and a control end receiving the second control signal; and
a second transistor having a first end coupling the output terminal, a second end coupling the first voltage multiplying capacitor, and a control end receiving the second control signal, wherein a type of the first transistor and a type of the second transistor are complementary.

17. The voltage multiplying circuit according to claim 16, wherein the second voltage transmission channel comprises:
a third transistor having a first end receiving the basic voltage, a second end coupling the second voltage multiplying capacitor, and a control end receiving the first control signal; and
a fourth transistor having a first end coupling the basic voltage, a second end coupling the second voltage multiplying capacitor, and a control end receiving the first control signal,
wherein a type of the third transistor and a type of the fourth transistor are complementary, and the type of the third transistor is the same as the type of the first transistor.

18. An impedance adjusting method of a signal switch chip, wherein the signal switch chip comprises a chip voltage and a transmission gate, and the impedance adjusting method comprises:
receiving a basic voltage to generate a multiplying voltage, wherein the multiplying voltage is N times the basic voltage, and N is a positive integer greater than 1; and
providing the multiplying voltage to the transmission gate to adjust an equivalent impedance of the transmission gate, wherein a voltage level of the multiplying voltage is greater than a voltage level of the chip voltage.

19. The impedance adjusting method according to claim 18, wherein the chip voltage is greater than or substantially equal to the basic voltage.
